(19) United States
(12) Patent Application Publication
(10) Pub. No.: US 2009/0153556 A1
(43) Pub. Date: Jun. 18, 2009

(54) Ray tracing device based on a pixel processing element and method thereof

(75) Inventors: Seung Woo Nam, Daejeon (KR); Do-Hyung Kim, Daejeon (KR); Jin Sung Choi, Daejeon (KR); Hyun Bin Kim, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/314,465

(22) Filed: Dec. 11, 2008

(30) Foreign Application Priority Data
Dec. 17, 2007 (KR) 10-2007-0132853

(51) Int. Cl. G06T 15/40

(52) U.S. Cl. 345/421

(57) ABSTRACT

A pixel processing element (PPE)-based ray tracing device, includes an internal shared memory for receiving and storing image data to be rendered; a PPE processor for performing parallel ray tracing on the image data on a pixel-by-pixel basis; and a shading processor for accumulatively calculating color values of respective pixels obtained by ray tracing and determining a final color value of each pixel. Further, A PPE-based ray tracing method, includes receiving image data to be rendered on a frame-by-frame basis; storing data having a high frequency of use among the input data in a hierarchical cache; performing parallel ray tracing on image data of each pixel stored in the hierarchical cache on a frame-by-frame basis; calculating a color value of each pixel from first and second rays and a direct ray in accordance with the ray tracing result, and accumulating the color values to obtain the color value of each pixel.

### CROSS-REFERENCE(S) TO RELATED APPLICATIONS

The present invention claims priority of Korean Patent Application No. 10-2007-0132853 filed on Dec. 17, 2007, which is incorporated herein by reference.

### FIELD OF THE INVENTION

The present invention relates to a ray tracing method, and more particularly, to a ray tracing device and method based on a pixel processing element (PPE) that are capable of increasing a ray tracing speed by repeatedly performing shading processing to generate a plurality of rays for one pixel through parallel pixel processing, to trace the plurality of generated rays on a scene including graphic data to be rendered, and to determine color values of pixels using a test result of intersection between the ray and a scene.

This work was supported by the IT R&D program of MIC/IITA. [2006-S-045-02, Development of Function Extensible Real-Time Renderer]

### BACKGROUND OF THE INVENTION

The conventional graphic technology includes modeling, animating, and rendering. Rendering consumes a lot of time. In movies, advertisements, and TV animations other than real-time games, rendering require a lot of effort and time. Rendering is directed to creating a two-dimensional image at a view where a camera views three-dimensional graphic data obtained by a modeling process. Rendering is implemented by a ray tracing method, a photon map, an irradiance caching method, etc. The ray tracing method is most widely used, although productions are reluctant to use it for a large time consumption.

In this situation, the ray trace must be necessarily provided with enhanced performance and speed. Most of conventional technologies have proposed hardware structures for real-time ray tracing. In particular, a SaarCor chip studied and developed by Sarland University and RayBox developed by ART VPS in Germany are commercially available. A method for accelerating real-time ray tracing using a graphic processing unit (GPU) has been actively studied by, for example, Stanford University and Utah University. However, these studies are still limited to a memory bandwidth, which acts as a fundamental bottleneck.

A conventional rendering technology using ray tracing will now be described with reference to FIG. 1.

FIG. 1 is a conceptual diagram illustrating a conventional ray tracing method. Referring to FIG. 1, if an image to be rendered is an image plane 100 and filling color values of pixels present on the image plane 100 is referred to as rendering, the color values of pixels may be color values of rays arriving at eyes via the pixels present on the image plane 100, i.e., the intensities and colors of the rays.

In order to calculate values of colors arriving at eyes via the pixels, the ray tracing method includes generating a ray from the eyes to the pixel, which is referred to as a first ray 102. When the first ray 102 meets a graphic object 104 to be rendered, a normal vector 106 of a surface is calculated at a hitting point 103 and used to generate a reflection ray 108 or a refraction ray (or a transmission ray) 110 depending on a material of the object. A direct ray 112 is also generated from a light source 113 to see if a shade is generated at the point where the first ray meets the object.

The generated ray is referred to as a second ray. When the second ray meets the graphic object 104, another second ray is generated and a direct ray is generated. This process is repeatedly performed to recursively calculate a color value of the material and an accumulated value is determined as the color value arriving via the pixel. Here, a designer or a renderer designer can determine a number of times the second ray is repeatedly generated. One or more reflection rays, refraction rays, or direct rays are generated by a probabilistic sampling method to obtain a soft image effect.

In the conventional ray trace method, the increasing number of times the second ray is generated geometrically increases the number of intersection tests between the ray and the object and calculation complexity for the hitting point. The calculation is performed recursively, making parallel calculation difficult.

The conventional intersection test uses a method for forming a scene in a bounding volume hierarchy structure or in a binary tree such as a kd-tree to accelerate intersection of the ray and an object in a scene. When the object in the scene is deformed or moved and rotated every frame, the hierarchy structure and the tree structure must be disadvantageously formed again. Use of an exclusive hardware or a graphic processing unit (GPU) to accelerate such an intersection test has been studied. However, when the tree and hierarchy structures constituting the scene are changed every frame, the exclusive hardware or the GPU must store the change in its memory, which decreases a memory bandwidth.

### SUMMARY OF THE INVENTION

The present invention provides a PPE-based ray tracing device and method capable of minimizing access to a main memory by using hierarchy and tree structures together to resolve an issue of a memory bandwidth for the hierarchy and tree structures changing every frame, and integrating a GPU and a ray tracing device into a display device to originally prevent a bus bottleneck between a CPU and the GPU, and capable of reducing a burden of ray tracing calculation on the CPU by performing ray tracing in parallel and performing processing on a pixel-by-pixel basis.

According to a first aspect of the present invention, there is provided a pixel processing element (PPE)-based ray tracing device, including: an internal shared memory for receiving and storing image data to be rendered; a PPE processor for performing parallel ray tracing on the image data on a pixel-by-pixel basis; and a shading processor for accumulatively calculating color values of respective pixels obtained by ray tracing and determining a final color value of each pixel.

It is preferable that the PPE processor includes a first-ray generator for generating a first ray from the sample table and the camera information input from the hierarchical cache; a total tree traversal block for performing a test to see if the first ray output from the first-ray generator intersects an object in the scene; and a second-ray generator for generating, as second rays, a reflection ray, a refraction ray, and a direct ray from the first ray using hitting information determined by the total tree traversal block and a material of the hitting object.

According to a second aspect of the present invention, there is provided a PPE-based ray tracing method, including: receiving image data to be rendered on a frame-by-frame basis; storing data having a high frequency of use among the input data in a hierarchical cache; performing parallel ray tracing on image data of each pixel stored in the hierarchical cache on a frame-by-frame basis; calculating a color value of each pixel from first and second rays and a direct ray in accordance with the ray tracing result, and accumulating the color values to obtain the color value of each pixel.

Further, the performing parallel ray tracing may include generating a first ray for each image data pixel from the sample table and the camera information input from the hierarchical cache; performing a test to see if the first ray intersects an object in a scene; and generating, as second rays, a reflection ray, a refraction ray, and a direct ray from the first ray when the first ray intersects the object.

With the PPE-ray tracing device and method according to the present invention, an object to be rendered can be processed in parallel on a pixel-by-pixel basis using the PPE, resulting in a scalable structure. The PPEs are integrally formed with a display device, thereby eliminating a bus bottleneck between a central processing unit (CPU) and a GPU. The CPU needs not perform rendering calculation, thereby reducing a burden on the CPU and resulting in a rendering exclusive hardware structure.

Furthermore, the device of the present invention includes a coordinate transformer for converting the ray into the ray in an object or a coordinate system (a local coordinate system) of the object to intersect prior to an intersection test in searching for hierarchy and tree structures constituting a scene, and an inverse coordinate transformer disposed at an output operating after the intersection test. Thus, it is unnecessary to update the tree and hierarchy structures in accordance with the rotation and movement of the object and accordingly to re-fetch the hierarchy and tree structures from the main memory, thereby increasing the memory bandwidth.

### BRIEF DESCRIPTION OF THE DRAWINGS

The above and other objects and features of the present invention will become apparent from the following description of embodiments given in conjunction with the accompanying drawings, in which:

FIG. 1 is a conceptual diagram illustrating a conventional process in which a ray intersects an object so that a second ray is generated on a surface of the object;

FIG. 2 illustrates an example of a PPE-based ray tracing and rendering device in accordance with the present invention;

FIG. 3 is an overall block diagram illustrating a PPE-based ray tracing device in accordance with the present invention;

FIG. 4 is a detailed block diagram illustrating a PPE processor in accordance with the present invention;

FIG. 5 is a block diagram illustrating a first-ray generator (RG1) in FIG. 3;

FIG. 6 is a block diagram illustrating a second-ray generator (RG2) in FIG. 3;

FIG. 7 is a block diagram illustrating a total tree traversal (T.T.T.) in FIG. 3;

FIG. 8 is a detailed block diagram illustrating a shading processor in FIG. 3;

FIG. 9a illustrates a hierarchical cache in accordance with the present invention;

FIG. 9b illustrates an example of a rendering equation of FIG. 9a;

FIG. 10 illustrates an example of creating and changing a tree structure on two scenes in accordance with an embodiment of the present invention;

FIG. 11 is a block diagram illustrating an intersection between a ray and a box in a tree structure that is not re-created even upon movement and rotation in accordance with the present invention; and

FIG. 12 is a block diagram illustrating an intersection between a ray and a triangle in a tree structure that is not re-created even upon movement and rotation in accordance with the present invention.

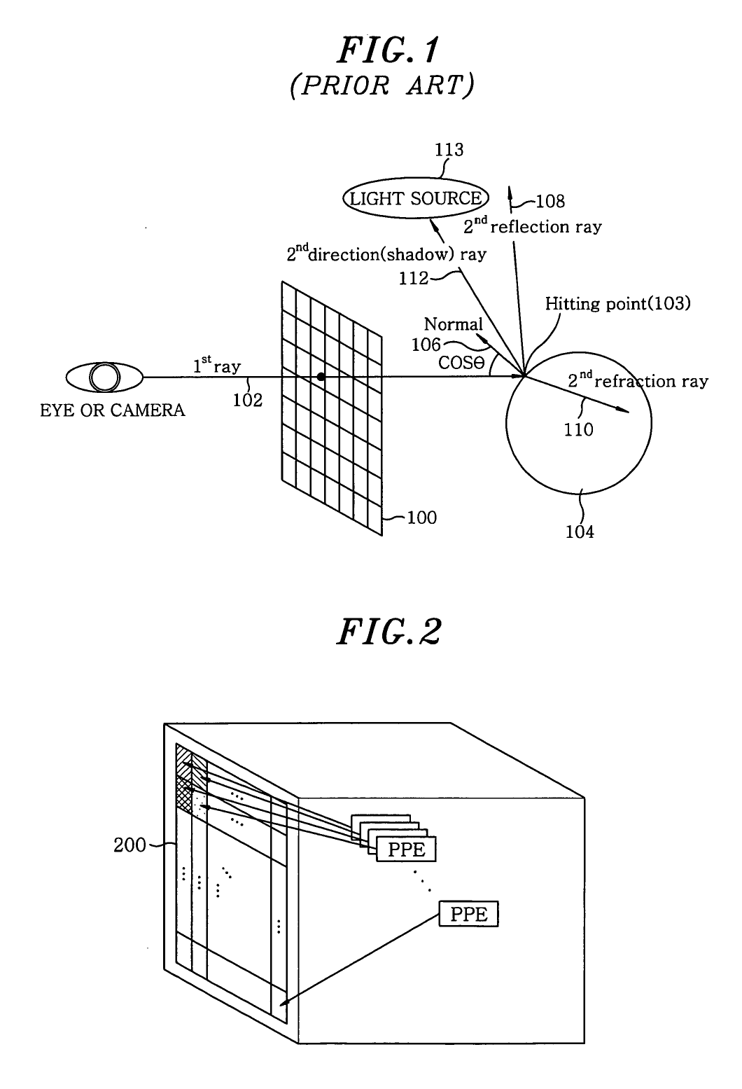

### DETAILED DESCRIPTION OF THE EMBODIMENTS

Hereinafter, embodiments of the present invention will be described in detail with reference to the accompanying drawings so that they can be readily implemented by those skilled in the art.

In a ray tracing scheme for rendering graphic data of three-dimensional graphic in real time, hierarchy and tree structures are used together to resolve an issue of a memory bandwidth for the hierarchy and tree structures changing in every frame, and a GPU and a ray tracing device are integrated into a display device to originally prevent a bus bottleneck between a CPU and the GPU, thereby minimizing access to a main memory. Ray tracing is performed in parallel and processing is performed on a pixel-by-pixel basis, thereby reducing a burden of ray tracing calculation on the CPU. Thus, the aforementioned object can be easily achieved.

Hereinafter, a ray tracing device and system based on a pixel processing element (PPE) in accordance with the present invention will be described with reference to the accompanying drawings.

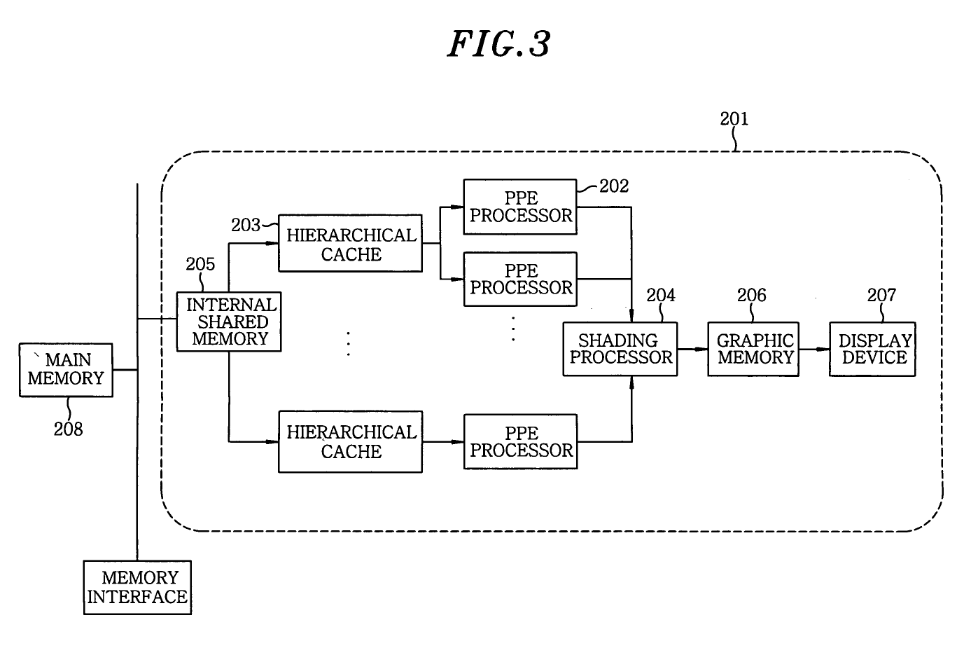

FIG. 2 illustrates an example of a ray tracing device with a display device in accordance with the present invention. A rendering result from a PPE processor is displayed on a display device 200.

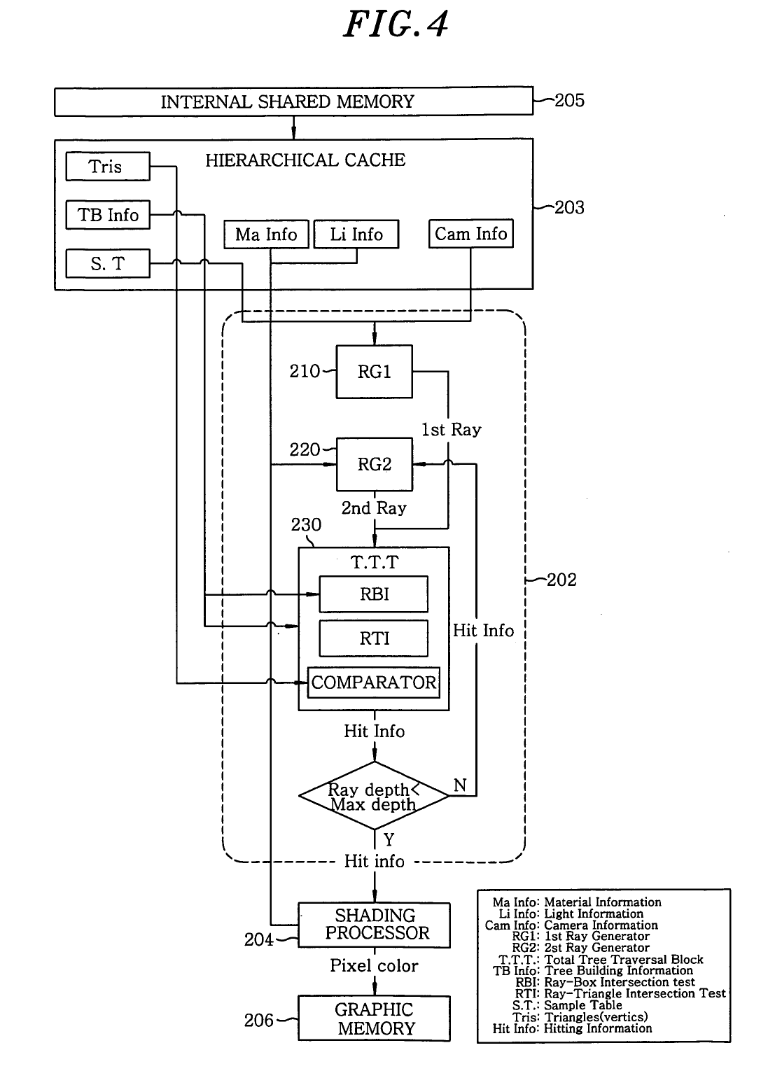

FIG. 3 is a block diagram illustrating a PPE-based ray tracing device 201 in accordance with the present invention.

Referring to FIG. 3, the PPE-based ray tracing device 201 includes an internal shared memory 205, hierarchical caches 203, PPE processors 202, a shading processor 204, a graphic memory 206, and a display device 207.

In operation, the internal shared memory 205 receives and stores image data to be rendered on a frame-by-frame basis from a main memory 208. The hierarchical cache 203 stores data having a high frequency of use among the data received from the internal shared memory 205. The PPE processor 202 performs parallel ray tracing for respective pixels on the image data stored on a frame-by-frame basis in the hierarchical cache 203. The shading processor 204 accumulatively calculates a variety of color values of the respective pixels as a result of ray tracing and determines the color value for each pixel.

That is, the PPE-based ray tracing device 201 receives data required for rendering from the main memory 208 and stores the data in the internal shared memory 205, and stores the data having a high frequency of use in the hierarchical cache 203 to prevent the PPE processors 202 from simultaneously accessing the memory and to recycle the data. The result values calculated by the PPE processors are used for the shading processor 204 to calculate the color value. The calculation result is stored in the graphic memory 206 and used for the display device 207 to display it as a final color value.

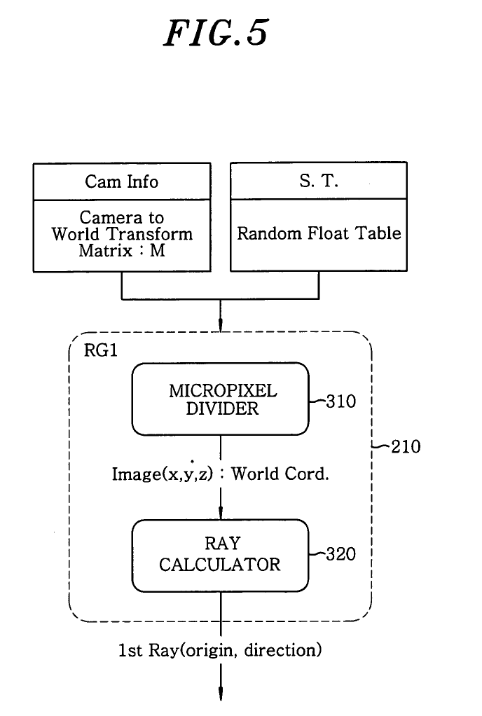

FIG. 4 is a functional block diagram illustrating the PPE processor 202 in the PPE-based ray tracing device in accordance with the present invention.

Operation of the PPE processor 202 will now be described in detail with reference to FIG. 4. First, when rays is given to pixels, frequently used data is stored in the cache memory 203 in accordance with data locality that the internal shared memory 205 is frequently accessed around the frequently used data. The stored data includes triangle data (Tris), tree or hierarchy building information (TB Info), a sampling table (S.T.), object material information (Ma Info), light information (Li Info), camera information (Cam Info), etc.

A first-ray generator RG1 210 of the PPE processor 202 then generates a first ray using the sampling table (S.T.) and the information stored in the cache memory 203. A total tree traversal block (T.T.T.) 230 performs an intersection test between the first ray and the object. In this case, the total tree traversal block stores data needed for shading in the hitting information (Hit Info). Based on the information contained in the hitting information, a second-ray generator (RG2) 220 generates a reflection ray, a refraction ray, and a direct ray. This process is repeatedly performed by a ray tracing depth to generate the second ray and the direct ray.

After the storage of the hitting information for all the rays is finished, the shading processor 204 determines the color value using the hitting information and the material information. The determined color value is stored in the graphic memory 206 and used for the display device 207 to display a color of the object using the color value determined by the shading processor 204.

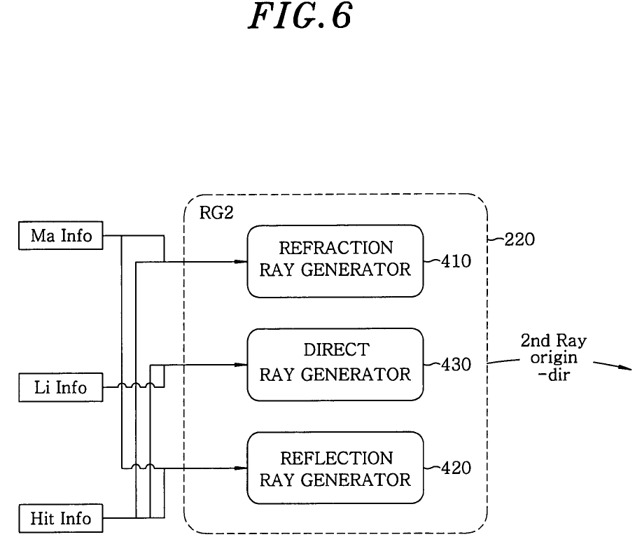

FIG. 5 is a detailed block diagram illustrating the first-ray generator RG1 210 of the PPE processor 202.

Referring to FIG. 5, the first-ray generator 210 receives the camera information (Cam Info) and data from the sampling table (S.T.). A micropixel divider 310 of the first-ray generator 210 divides a pixel into sub pixels having the same area depending on a sampling number, and allocates the color value from the sampling table as a color value corresponding to each sampling using a probabilistic scheme.

The first-ray generator 210 then generates the first ray. In order to eliminate a shortcoming of updating the tree or hierarchy building information (TB Info) upon rotation and movement of the object in a scene for every frame, the present invention includes a matrix multiplier or a coordinate transformer for coordinate-converting the ray rather than the object, so that tree and hierarchical information for the object is kept unchanged.

In the case of the rays for tracing, N samples are included within a pixel of the image to be rendered from a camera or an eye, in which a camera lens or a camera location becomes a starting point of the ray. The micropixel divider 310 divides one pixel on an image plane into several sub pixels having the same area.

A ray calculator 320 performs probabilistic random sampling on one point within the micropixel using the sampling table, and determines a direction vector of the ray in a direction from the starting point of the ray to the sampled point in the micropixel.

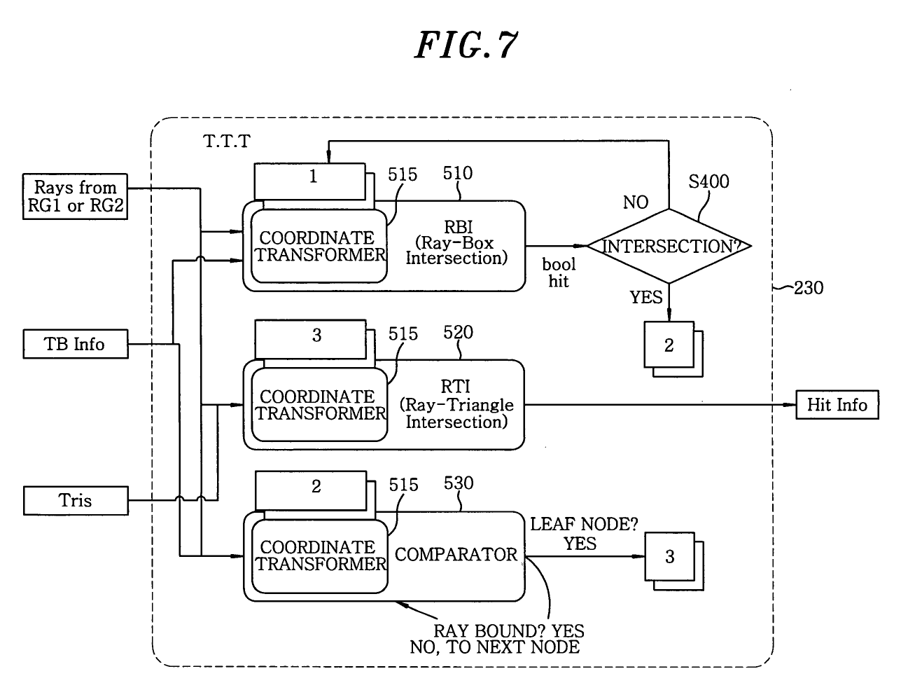

FIG. 6 is a detailed block diagram illustrating the second-ray generator RG2 220 of the PPE processor 202.

Referring to FIG. 6, the second-ray generator 220 includes a reflection ray generator (RLRG) 420, a refraction ray generator (RRRG) 410, and a direct light ray generator (DLRG) 430. The second-ray generator 220 generates a reflection ray, a refraction ray, and a direct ray using hitting information (Hit Info), object material information (Ma Info), and light information (Li Info).

That is, the reflection ray generator 420 generates the reflection ray when the first ray intersects the object, and the refraction ray generator 410 generates the refraction ray when the first ray intersects the object. The direct ray generator 430 generates the direct ray directed to the light source at a point where the first ray intersects the object.

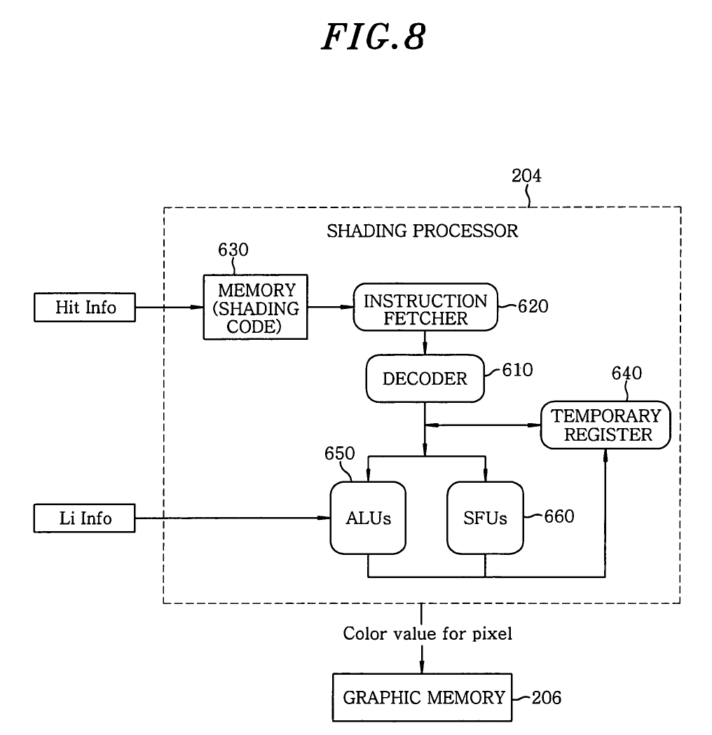

FIG. 7 is a detailed block diagram illustrating the total tree traversal block (i.e., T.T.T.) 230 of the PPE processor 202.

Referring to FIG. 7, the total tree traversal block 230 includes a ray-bounding volume intersection processor (i.e., a Ray-Box Intersection Test; RBI) 510, a ray-object intersection processor (i.e., Ray-Triangle Intersection Test; RTI) 520, and a comparator 530.

The RBI 510 receives the hierarchy or tree structure forming the scene, the first and second generated rays, and an object on a leaf node of the hierarchy or tree structure, and processes intersection of the rays and the bounding volume. That is, the RBI 510 performs a test to see if the first and second rays intersect the bounding volume constituting the hierarchy structure of the object (assumed herein as a box) (S400). If the first and second rays intersect the bounding volume, the RBI 510 continues to search for the bounding volume on a next hierarchy.

When there is a binary tree structure within the bounding volume, the total tree traversal block 230 performs operation 2 as shown in FIG. 7. A comparator 530 for searching for the binary tree searches for a final leaf node. The RTI 520 then performs a test to see if the ray intersects an object present in the searched leaf node (assumed herein as a triangle). If the ray intersects the object, the RTI 520 stores the hitting information (Hit Info).

In this case, the inputs include triangle data, tree or hierarchy building information (TB Info), the first or second ray, or rays resulting from the second ray. In the present invention, in particular, in order to resolve a problem of updating of the tree or hierarchy building information for every frame, each of the RBI 510, the RTI 520, and the comparator 530 includes a coordinate transformer 515 for moving the ray to a local coordinate of the object.

Accordingly, tree or hierarchy building information for an object that performs rigid-body motion, i.e., rotation and parallel translation can be used as it is, such that it is unnecessary to re-fetch tree or hierarchy building information of every frame from the main memory 208. This can increase the memory bandwidth.

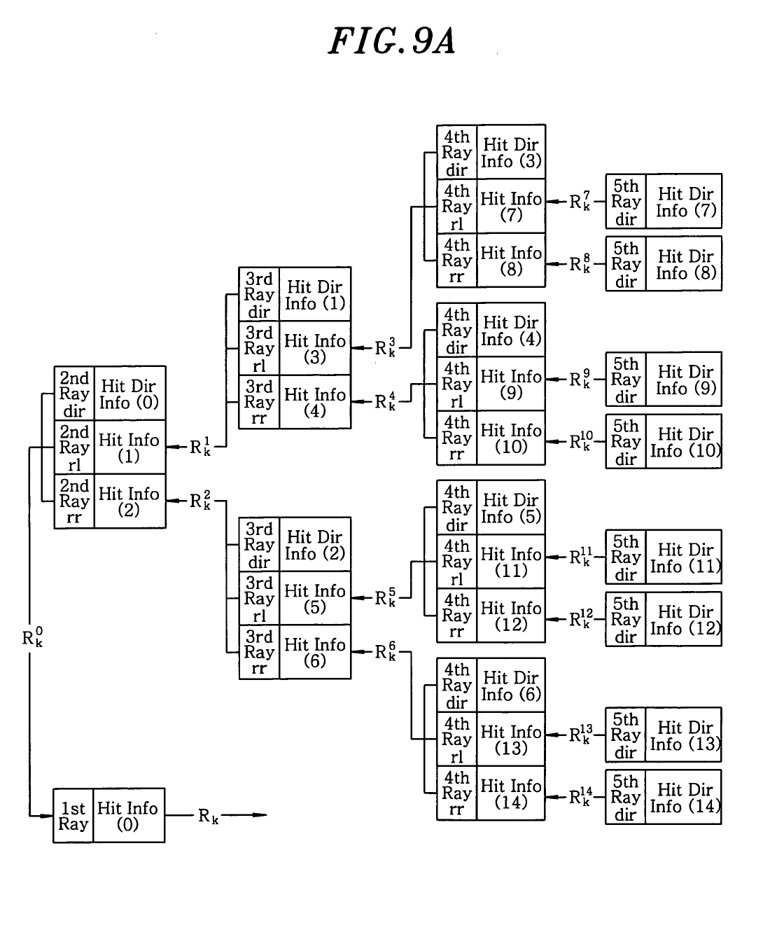

FIG. 8 is a detailed block diagram illustrating the shading processor 204 for calculating and determining color values of pixels using the hitting information (Hit Info).

Referring to FIG. 8, the shading processor 204 of the present invention includes a decoder 610, an instruction fetcher 620, a memory 630, a temporary register 640, and an arithmetic unit (ALU) 650 for performing calculation in response to an instruction, and a special function unit (SFU) 660.

The memory 630 stores a shade code in accordance with the material of the object using the hitting information output from the total tree traversal block 230. The instruction fetcher 620 fetches the stored shade code from the memory 630. In this case, the shade code is for processing the color value of each pixel to correspond to a user-selected effect.

The decoder 610 decodes the shade code from the instruction fetcher 620, analyzes a color implementation effect instructed by a user, and allows the result to be processed as a color value corresponding to the user-selected effect using the hitting information (Hit Info) and the light information (Li Info).

The temporary register 640 stores a value as a result of decoding the shade code, and also stores an intermediate color value of each pixel calculated by the arithmetic unit 650 and the SFU 660, which calculate the color values of pixels using the hitting information and the light information in response to the shading instruction analyzed by the decoder 610.

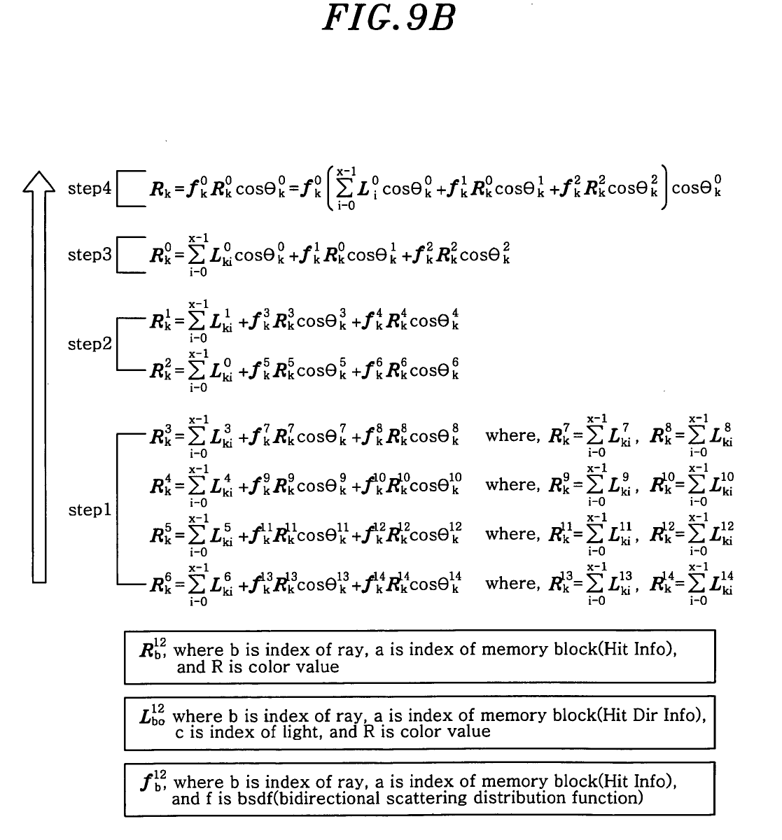

FIG. 9a illustrates types of buffers for storing generated rays and types and number of buffers for storing hitting information when each generated ray intersects an object, where a ray tracing depth is 5, in accordance with an embodiment of the present invention.

Referring to FIG. 9a, one or more first rays are generated for each pixel, and one or more second ray exists for each of the first rays. The generated rays are stored in a corresponding buffer, and the hitting information is used to generate the second ray and a direct ray.

Here, Rₖ denotes color values of pixels obtained by accumulating color values from the first ray, the second ray, and the direct ray, and R^{a}_{b} denotes a color value of the k-th ray according to the ray tracing depth. When n first rays are generated, the value k ranges from 0 to n−1. In this case, the value a denotes an index of a memory block and the value b denotes an index for the ray.

FIG. 9b shows an example of a rendering equation for calculating color values of pixels based on the hitting information stored in the buffers shown in FIG. 9a.

Referring to FIG. 9b, L^{a}_{bc} denotes an amount of light and a color value at a hitting point, a denotes an index of the memory block, b denotes an index of the direct ray, and c denotes an index of the light source. f^{a}_{bc} denotes a bidirectional scattering distribution function (BSDF), and a, b, and c denote indexes of the memory blocks, as in FIG. 9a.

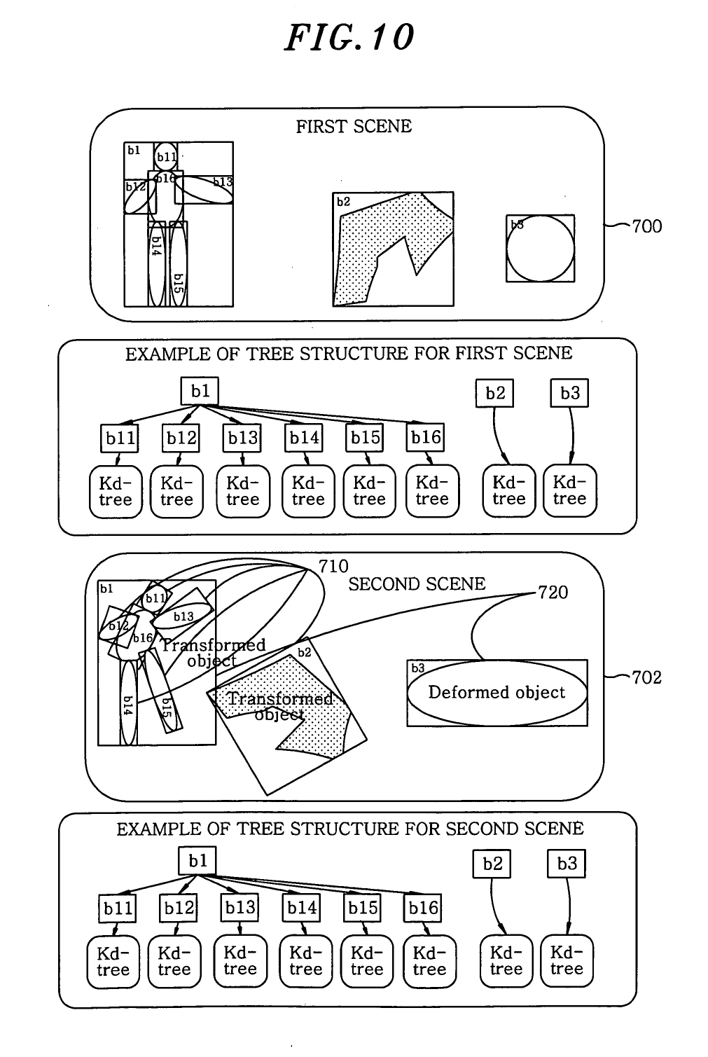

FIG. 10 illustrates an example of creating a hierarchy structure for a bounding volume and a binary tree in the bounding volume on a given scene in accordance with an embodiment of the present invention.

Referring to FIG. 10, bounding boxes b1, b2, and b3 are independently created in accordance with a mesh on a first scene 700, in which the bounding box b1 consists of b11, b12, b13, b14, b15, and b16, and b11 to b16 are organized in a binary tree (or a kd-tree).

In this case, it can be seen that, on a second scene 702, b1 changes in size and location, b2 in rotation, and b3 in shape, as opposed to the first scene 700. It can also be seen that b11 to b15 change only in rotation and location. In this case, a portion 710 of the hierarchy and tree structures of the second scene 702 is the same as that of the first scene 700 and accordingly may be recycled instead of being re-created. However, in the case of the object 720 suffering from a change in the size of the bounding volume or from mesh deformation, the bounding box may be internally updated.

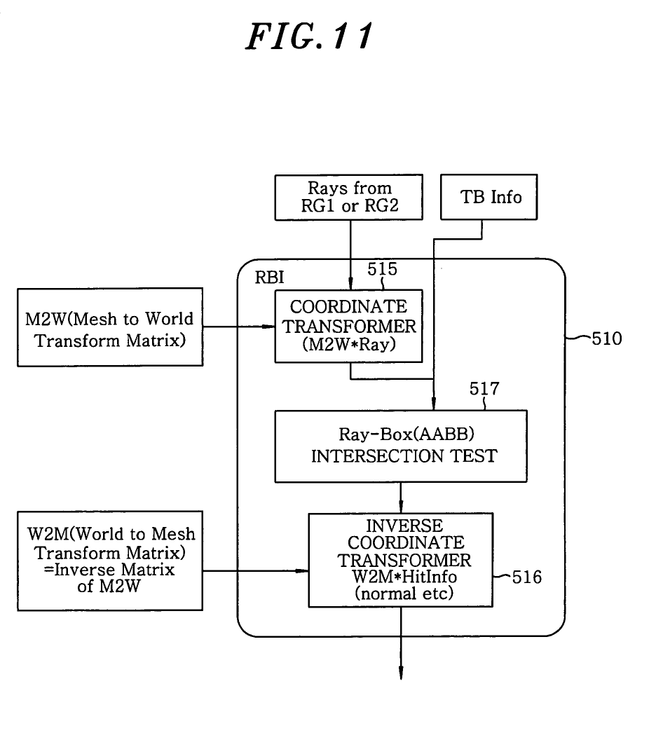

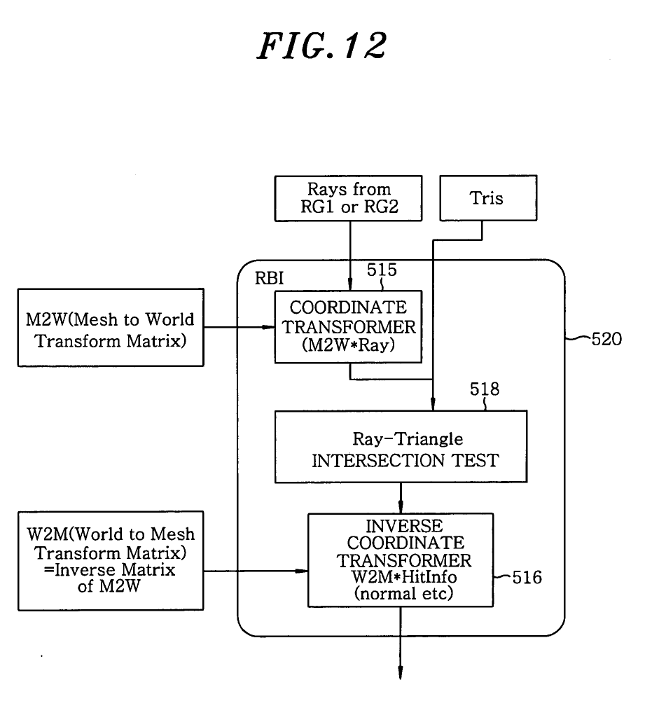

FIG. 11 is a block diagram illustrating the detailed constitution of the ray-bounding volume intersection processor (RBI) 510, and FIG. 12 is a block diagram illustrating the detailed constitution of the ray-object intersection processor (RTI) 520.

Referring to FIGS. 11 and 12, each intersection processor 510 or 520 in the present invention includes a coordinate transformer 515 at an input and an inverse coordinate transformer 516 at an output. Thus, prior to performing a test to see if a ray intersects a bounding volume and an object in the tree, the coordinate transformer 515 converts the ray into a ray in a coordinate system of the object (a local coordinate system). The intersection processor 510 or 520 then performs the intersection test 517 or 518. The inverse coordinate transformer 516 performs inverse coordinate conversion on a normal vector and a hitting point in the hitting information (Hit Info) of the output result, so that rotation and movement of the object does not change the tree and hierarchy structures.

Thus, it is unnecessary to update the tree and hierarchy structures in accordance with the rotation and movement of the object and to re-fetch the hierarchy and tree structures from the main memory, thereby increasing the memory bandwidth.

While the invention has been shown and described with respect to the embodiments, it will be understood by those skilled in the art that various changes and modifications may be made without departing from the scope of the invention as defined in the following claims.

What is claimed is:

1. A pixel processing element (PPE)-based ray tracing device, comprising:
an internal shared memory for receiving and storing image data to be rendered;
a PPE processor for performing parallel ray tracing on the image data on a pixel-by-pixel basis; and
a shading processor for accumulatively calculating color values of respective pixels obtained by ray tracing and determining a final color value of each pixel.

2. The device of claim 1, further comprising a hierarchical cache for storing image data having a high frequency of use among the image data input from the internal shared memory and providing the image data to the PPE processor.

3. The device of claim 2, wherein the input image data stored in the hierarchical cache comprises an object constituting a scene of every frame, hierarchy and tree structures constituting the scene, a sampling table for ray sampling, material information for the object, light information, or camera information.

4. The device of claim 1, further comprising:
a graphic memory for storing the color value of each pixel determined by the shading processor; and
a display device for displaying the color value of each pixel stored in the graphic memory.

5. The device of claim 3, wherein the PPE processor comprises:
a first-ray generator for generating a first ray from the sample table and the camera information input from the hierarchical cache;
a total tree traversal block for performing a test to see if the first ray output from the first-ray generator intersects an object in the scene; and
a second-ray generator for generating, as second rays, a reflection ray, a refraction ray, and a direct ray from the first ray using hitting information determined by the total tree traversal block and a material of the hitting object.

6. The device of claim 5, wherein-the first-ray generator comprises:
a micropixel divider for dividing one pixel on an image plane into several micropixels having the same area using the camera information and the sampling table; and
a ray calculator for performing probabilistic random sampling on one point in the micropixel using the sampling table, and determining a direction vector of the ray in a direction from a starting point of the ray to a sampled point in the micropixel.

7. The device of claim 5, wherein the second-ray generator comprises:
a reflection ray generator for generating a reflection ray when the first ray intersects the object;
a refraction ray generator for generating a refraction ray when the first ray intersects the object; and
a direct ray generator for generating a direct ray directed to a light source at a point where the first ray intersects the object.

8. The device of claim 5, wherein the total tree traversal block comprises:
a ray-bounding volume intersection processor (RBI) for performing a test on an intersection between the first ray and a bounding volume constituting the hierarchy structure of the object;
a ray-object intersection processor (RTI) for performing a test on an intersection between the first ray and the object and storing hitting information; and
a comparator for performing binary tree search on the first and second rays when the first ray intersects the bounding volume and determining whether the intersection occurs at a final leaf node of the bounding volume.

9. The device of claim 8, wherein the ray-object intersection processor receives hitting information between the first ray and the bounding volume at the final leaf node from the comparator, and performs a test on an intersection between the ray and the object.

10. The device of claim 8, wherein the ray-bounding volume intersection processor, the ray-object intersection processor, and the comparator comprise a coordinate transformer for converting the first ray into a ray at a local coordinate of the bounding volume to be tested for intersection with the ray.

11. The device of claim 10, wherein the ray-bounding volume intersection processor performs a test on an intersection between the first and second rays, converted into rays at a local coordinate of the bounding volume by the coordinate transformer, and the bounding volume, and then performs inverse coordinate conversion on the rays so that tree and hierarchy structures for the bounding volume are kept unchanged.

12. The device of claim 10, wherein the ray-object intersection processor performs a test on an intersection between the first and the second ray, converted into rays at a local coordinate of the object by the coordinate transformer, and the object, and then performs inverse coordinate conversion on the rays so that tree and hierarchy structures for the object are kept unchanged.

13. The device of claim 5, wherein the shading processor comprises:
a memory for storing a shade code in accordance with the material of the object using the hitting information output from the total tree traversal block;
an instruction fetcher for fetching the shade code;
a decoder for decoding the shade code;
a temporary register for storing a value as a result of decoding the shade code;
an arithmetic unit (ALU) for receiving light information and performing shading calculation in response to the shading instruction to calculate a color value for each pixel; and
a special function unit (SFU) for calculating a particular calculation log, a trigonometric function or a power used for the shading calculation.

14. The device of claim 13, wherein the arithmetic unit calculates a color value of each pixel from the first and second rays and the direct ray based on the light information and the hitting information, and accumulates the color values to determine the color value of each pixel.

15. The device of claim 14, wherein, for each pixel, one or more first rays are generated and one or more second rays are generated for each of the first rays.

16. The device of claim 15, wherein when the number of the first rays is N, the number of hitting information calculated based on the first or second ray at a ray search depth I is 2ⁱ⁻¹*N.

17. A PPE-based ray tracing method, comprising:
receiving image data to be rendered on a frame-by-frame basis;
storing data having a high frequency of use among the input data in a hierarchical cache;
performing parallel ray tracing on image data of each pixel stored in the hierarchical cache on a frame-by-frame basis;
calculating a color value of each pixel from first and second rays and a direct ray in accordance with the ray tracing result, and accumulating the color values to obtain the color value of each pixel.

18. The method of claim 17, wherein in the storing data, the input image data stored in the hierarchical cache comprises an object constituting a scene of every frame, hierarchy and tree structures constituting the scene, a sampling table for ray sampling, material information for the object, light information, or camera information.

19. The method of claim 17, wherein the performing parallel ray tracing comprises:
generating a first ray for each image data pixel from the sample table and the camera information input from the hierarchical cache;
performing a test to see if the first ray intersects an object in a scene; and
generating, as second rays, a reflection ray, a refraction ray, and a direct ray from the first ray when the first ray intersects the object.

20. The method of claim 19, wherein the generating a first ray comprises:
dividing one pixel on an image plane into several micropixels having the same area using the camera information and the sampling table; and
performing probabilistic random sampling on one point in the micropixel using the sampling table, and determining a direction vector of the first ray in a direction from a starting point of the first ray to a sampled point in the micropixel.

21. The method of claim 19, wherein the performing a test comprises:
performing a test on an intersection between the first ray and a bounding volume constituting the hierarchy structure of the object;
performing a test on an intersection between the first ray and the object and storing hitting information; and
performing binary tree search on the first ray when the first ray intersects the bounding volume and determining whether the intersection occurs at a final leaf node of the bounding volume to see if the first ray intersects the object.

22. The method of claim 19, wherein the generating, as second rays, a reflection ray, a refraction ray, and a direct ray comprises:
generating a reflection ray when the first ray intersects the object;
generating a refraction ray when the first ray intersects the object; and
generating a direct ray directed to a light source at a point where the first ray intersects the object.

23. The method of claim 19, wherein the calculating a color value of each pixel from first and second rays and a direct ray comprises:
fetching a shade code according to the material of the object using the hitting information;
decoding the shade code; and
receiving light information and performing shading calculation in response to a shading instruction to calculate a color value for each pixel.

24. The method of claim 23, wherein the receiving light information and performing shading calculation comprises:
calculating the color value of each pixel from the first and second rays and the direct ray based on the light information and the hitting information; and
accumulating the calculated color values to determine the color value of each pixel.

25. The method of claim 24, wherein in the calculating the color value of each pixel from the first and second rays and the direct ray based on the light information and the hitting information, for each pixel, one or more first rays are generated and one or more second rays are generated for each of the first ray and when the number of the first rays is N, the number of hitting information calculated based on the first or second ray at a ray search depth I is 2ⁱ⁻¹*N.
